(19) United States
(12) Patent Application Publication
(10) Pub. No.: US 2015/0316012 A1
(43) Pub. Date: Nov. 5, 2015

(54) PUMP UNIT

(71) Applicant: DELPHI INTERNATIONAL OPERATIONS LUXEMBOURG S.A.R. L., Bascharage (LU)

(72) Inventor: THOMAS MAGILL, LONDON (GB)

(21) Appl. No.: 14/649,578

(22) PCT Filed: Nov. 14, 2013
(86) PCT No.: PCT/EP2013/073840

§ 371 Date: Jun. 4, 2015

(30) Foreign Application Priority Data
Dec. 18, 2012 (EP) 12197714.4

(51) Int. Cl. F02M 59/02; F04B 53/22; F04B 53/16; F04B 19/22; F04B 53/12

(52) U.S. Cl. CPC F02M 59/027; F04B 19/22; F04B 53/125; F04B 53/16; F04B 53/22

(57) ABSTRACT

A pump unit for a fuel injection system is disclosed. The pump unit has a low pressure fuel supply line and a high pressure fuel outlet. A pumping chamber having a plunger is operable to perform a pumping cycle comprising a pumping stroke and a filling stroke. The pump unit also includes an inlet valve having an inlet valve member movable between an open position for permitting the supply of fuel to the pumping chamber from the low pressure fuel supply line and a closed position for inhibiting the supply of fuel from the pumping chamber to the low pressure supply line. An outlet valve is provided in the high pressure fuel outlet. The pump unit also includes means for coupling the plunger to the inlet valve member. The present application also relates to a method of operating a pump unit; and a valve for a fuel injection system.

### CROSS REFERENCE TO RELATED APPLICATIONS

This application is a national stage application under 35 U.S.C. 371 of PCT Application No. PCT/EP2013/073840 having an international filing date of 14 Nov. 2013, which designated the United States, which PCT application claimed the benefit of European Patent Application number 12197714.4 filed on 18 Dec. 2012, the entire disclosure of each of which are hereby incorporated herein by reference.

### TECHNICAL FIELD

The present invention relates to a pump unit for a fuel injection system; and a method of operating a pump unit.

### BACKGROUND OF THE INVENTION

It is known from the Applicant's earlier application WO 2011/003789 to provide a pump unit comprising an axial inlet valve. A spring-biased inlet valve member is provided for controlling the supply of fuel to a pumping chamber from a low pressure supply line. The inlet valve member is displaced to an open or closed position in response to a positive or negative pressure differential. However, there are various factors that dictate the pressure differential across the inlet valve member. For example, the pressure differential can be relatively small at low speed and low pressure (as may occur near engine start-up). GB739528 discloses a pump unit as per the preamble of claim 1.

The present invention, at least in certain embodiments, sets out to provide an improved pump unit

### SUMMARY OF THE INVENTION

Aspects of the present invention relate to a pump unit; and a method of operating a pump unit.

A further aspect of the present invention relates to a pump unit for a fuel injection system, the pump unit comprising:

a low pressure fuel supply line;

a pumping chamber having a plunger operable to perform a pumping cycle comprising a pumping stroke and a filling stroke;

an inlet valve having an inlet valve member movable between an open position for permitting the supply of fuel to the pumping chamber from the low pressure fuel supply line and a closed position for inhibiting the supply of fuel from the pumping chamber to the low pressure supply line; and

a high pressure fuel outlet having an outlet valve;

wherein the pump unit further comprises coupling means for coupling the plunger to the inlet valve member. By coupling the plunger to the inlet valve member, the plunger can apply a lifting force to the inlet valve member during at least some of said filling stroke. The lifting force can, for example, be applied to the inlet valve member at the beginning of the filling stroke. At low operating speeds and/or low operating pressures, the coupling means can promote opening of the inlet valve member. Equally, at least in certain embodiments, the coupling means can provide quicker operation of the inlet valve member. The coupling means could have a variable geometry, for example to accommodate different stroke lengths of the plunger and the inlet valve member. Alternatively, the coupling means can be arranged releasably to couple the plunger to the inlet valve member.

A cam, for example mounted to a rotating camshaft, can be provided for driving the plunger to perform said pumping stroke. An actuator or a spring can be provided for driving the plunger to perform said filling stroke. The inlet valve member can travel in a bore formed in a pump barrel.

At least in certain embodiments, the coupling means can transfer a lifting force from the plunger to the inlet valve member to assist with opening of the pumping chamber. The coupling means can be configured to lift the inlet valve member from said closed position as the plunger performs the filling stroke. The coupling means can be arranged to displace the inlet valve member from its closed position towards its open position. The lifting force applied can complement a hydraulic opening force resulting from a pressure differential across the inlet valve member as the plunger performs the filling stroke. Indeed, in certain embodiments, the lifting force may be sufficient to displace the inlet valve member to its open position without relying on a hydraulic opening force.

The plunger and the inlet valve member can have different stroke lengths. The different stroke lengths can be accommodated by a variable geometry coupling, such as a spring member. Alternatively, by configuring the coupling means releasably to couple the inlet valve member and the plunger, the different stroke lengths can be accommodated. The pump unit can comprise a decoupler or decoupling means for decoupling the plunger and the inlet valve member. The decoupling means could be in the form of a mechanical, hydraulic or magnetic arrangement. The decoupling means can, for example, be arranged to inhibit travel of the inlet valve member. The decoupling means can comprise a valve stop for limiting the travel of the inlet valve member. Thus, the valve stop can define the open position for the inlet valve member. The valve stop could be provided on the pump barrel to limit travel of the inlet valve member. For example, the valve stop could be an annular stop formed in the valve barrel to limit travel of the inlet valve member. Alternatively, or in addition, a projection, such as a flange or a collar, could be provided on the inlet valve member to limit travel. The projection could, for example, co-operate with the pump barrel to define the open position of the inlet valve member.

The coupling means can comprise a mechanical coupling between said plunger and said inlet valve member. The mechanical coupling can be arranged releasably to couple the inlet valve member and the plunger. The mechanical coupling can comprise a coupling member disposed on either the plunger or the inlet valve member. The coupling member can be configured to releasably engage a cooperating aperture, detent or projection formed on the other of said plunger and inlet valve member. The coupling member could comprise a resilient member or a spring-biased member. For example, the coupling member could be pivotally mounted and a spring member provided to bias the coupling member into an engagement position. The mechanical coupling can form a releasable mechanical latch. The mechanical coupling could also be established by an interference fit between the plunger and the inlet valve member. The mechanical coupling could comprise a linked spring arranged to apply a lifting force to the inlet valve member as the plunger performs the filling stroke. The linked spring could extend once the inlet valve member has reached its open position to accommodate the longer stroke length of the plunger. It is envisaged that the linked spring would remain connected to the inlet valve member and the plunger.

A hydraulic coupling could be established between the plunger and the inlet valve member. The hydraulic coupling could be released when the pressure differential across the inlet valve member decreases.

Alternatively, the coupling means can take the form of a magnetic coupling. The magnetic coupling can be established by one or more permanent magnets and/or one or more electromagnets. The magnet(s) and/or the electromagnet(s) can be disposed on the plunger and/or the inlet valve member. The magnetic coupling can be established when the plunger is proximal the inlet valve member, for example when the plunger is in its top dead centre position (i.e. at the top of its stroke). When the plunger is in its top dead centre position, the plunger can contact the inlet valve member while the inlet valve member is in its closed position (i.e. located in a valve seat to seal the pumping chamber).

The coupling means can comprise a magnet (either a permanent magnet or an electromagnet) disposed on a first end of the plunger proximal the inlet valve member. An aperture, such as a bore, can be formed in the inlet valve member for accommodating the magnet when the plunger is in its top dead centre position. The aperture can be sized to maintain a gap between the magnet and the inlet valve member. A complementary magnet could optionally be provided on the inlet valve member for cooperating with the magnet disposed on the plunger. Alternatively, the magnet could be disposed on the inlet valve member.

The magnet can, for example, be a rare earth magnet. For example, the magnet can be a Neodymium magnet. For example, a Neodymium magnet of type NEH or NZ has an operating temperature of 200° C. (392° F.) and a Curie temperature of ≧300° C. Similarly, a Neodymium magnet of type NUH has an operating temperature of 180° C. (356° F.) and a Curie temperature of ≧300° C. These magnets have a residual flux density of ˜1 Ts. Other types of magnets can also be employed. The magnets can be bonded or mechanically secured in place.

According to a further aspect of the present invention there is provided a pump unit for a fuel injection system, the pump unit comprising:

a plunger disposed in a pumping chamber and operable to perform a pumping cycle;

an inlet valve having an inlet valve member movable between an open position for permitting the supply of fuel to the pumping chamber and a closed position for inhibiting the supply of fuel from the pumping chamber to the low pressure supply line; and

wherein the pump unit further comprises coupling means for coupling the plunger to the inlet valve member. The releasable coupling means can comprise a mechanical and/or magnetic coupling arrangement. The coupling means could provide a variable geometry coupling between the plunger and the inlet valve member, for example to accommodate different stroke lengths. Alternatively, the coupling means can be arranged releasably to couple the plunger to the inlet valve member.

According to a still further aspect of the present invention there is provided a method of operating a pump unit, the method comprising:

reciprocating a plunger within a pumping chamber to perform a pumping cycle comprising a pumping stroke and a filling stroke;

displacing an inlet valve member between an open position for permitting the supply of fuel to the pumping chamber from a low pressure fuel supply line and a closed position for inhibiting the supply of fuel from the pumping chamber to the low pressure supply line;

coupling the plunger to the inlet valve member to lift the inlet valve member from said closed position. A lifting force can be transferred from the plunger to the inlet valve member when they are coupled to each other. The plunger and the inlet valve member can be coupled to each other during at least part of the filling stroke. At least in certain embodiments, opening the pumping chamber can be expedited at the beginning of the filling stroke. This arrangement may prove advantageous at low speed and/or low pressure; and/or at high speed.

The plunger can be releasably coupled to the inlet valve member to accommodate different stroke lengths. The method can also comprise decoupling the plunger and the inlet valve member partway through the filling stroke of the plunger. Thus, the method can accommodate different stroke lengths of the plunger and the inlet valve member. The plunger and the inlet valve member can be decoupled by limiting the travel of the inlet valve member. For example, a stop, such as a valve seat, can be provided to define the open position of said inlet valve member.

The method can comprise coupling the plunger to the inlet valve member as the plunger completes said pumping stroke. Thus, the inlet valve member can be coupled to the plunger when the plunger is proximal to, or at the top dead centre position.

The use of relative terms herein to define direction (including upwards, downwards and derivatives thereof), orientation and position (including upper and lower) are with reference to the arrangement illustrated in the accompanying FIGURE and are not to be construed as limiting on the scope of protection conferred.

Within the scope of this application it is expressly intended that the various aspects, embodiments, examples and alternatives set out in the preceding paragraphs, in the claims and/or in the following description and drawings, and in particular the individual features thereof, may be taken independently or in any combination. For example, features described with reference to one embodiment are applicable to all embodiments, unless such features are incompatible.

### BRIEF DESCRIPTION OF THE DRAWINGS

An embodiment of the present invention will now be described, by way of example only, with reference to the accompanying figures, in which:

FIG. 1 shows a schematic representation of a pump unit in accordance with the present invention.

### DETAILED DESCRIPTION OF AN EMBODIMENT

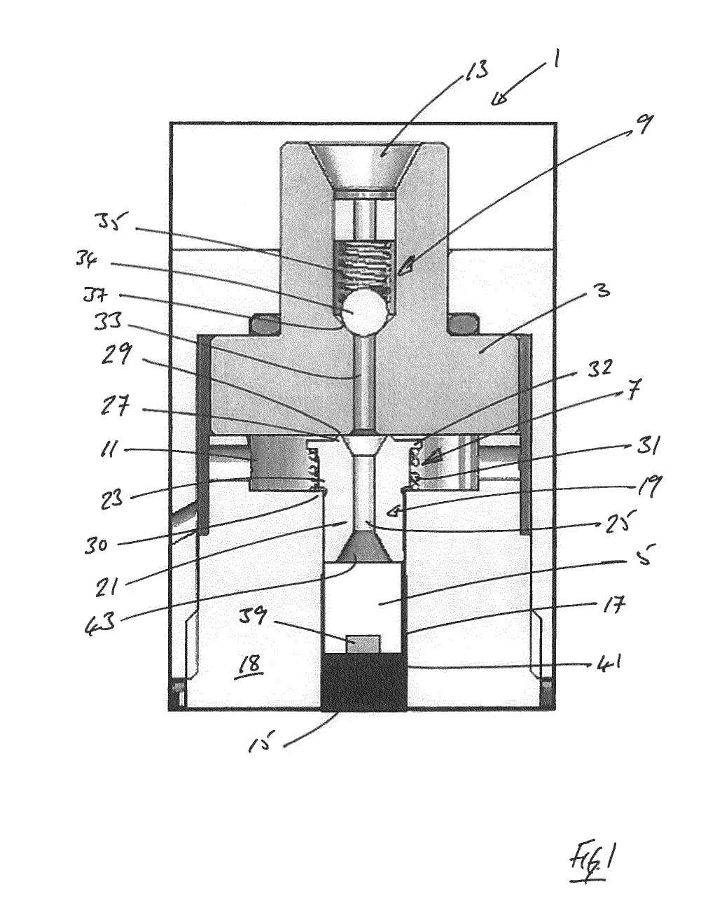

A pump unit 1 according to a first embodiment of the present invention is shown in FIG. 1. The pump unit 1 comprises a pump head 3, a pumping chamber 5, an inlet valve 7 and an outlet valve 9. The fuel is supplied to the pumping chamber 5 from a low pressure inlet gallery 11 and is expelled from the pumping chamber 5 to a high pressure manifold 13.

A plunger 15 is provided in the pumping chamber 5 for pressurising fuel. A cam mounted to a rotatable camshaft (not shown) cooperates with a lower end of the plunger 15 to reciprocate the plunger 15. In use, the plunger 15 performs a pumping cycle comprising a pumping stroke and a filling stroke. The plunger 15 is mounted in a bore 17 formed in a pump barrel 18 and a seal is formed between the plunger 15 and the barrel 18 in known manner.

The inlet valve 7 comprises an inlet valve member 19 for controlling the flow of fuel into the pumping chamber 5. The inlet valve member 19 is movable axially between an open position in which the pumping chamber 5 is in fluid communication with the low pressure inlet gallery 11; and a closed position in which fluid communication between the pump chamber 5 and the low pressure inlet gallery 11 is exhausted.

The inlet valve member 19 comprises a cylindrical body 21 having an annular collar 23; an axial bore 25; and an upper annular valve 27. The annular valve 27 is formed at the top of the cylindrical body 21 and cooperates with a top valve seat 29 formed in the pump head 3 to seal the pumping chamber 5 when the inlet valve member 19 is in its closed position, as shown in FIG. 1. An inlet return spring 31 is provided to bias the inlet valve member 19 towards said closed position. The inlet return spring 31 cooperates with an annular flange 32 disposed at the top of the cylindrical body 21. An upper surface of the barrel 18 forms an annular stop 30 for cooperating with the collar 23 to limit the travel of the inlet valve member 19, thereby defining the open position of the inlet valve member 19.

An outer wall of the cylindrical body 21 forms a seal with an inside wall of the bore 17. The axial bore 25 extends through the cylindrical body 21 and forms the sole inlet/outlet for the pumping chamber 5. In use, when the inlet valve member 19 is in said closed position, high pressure fuel in the axial bore 25 causes the cylindrical body 21 to expand radially and provide an improved seal with the bore 17. When the inlet valve member 19 is in said open position (i.e. the collar 23 abuts the annular stop 30), the inlet gallery 11 is in fluid communication with the pumping chamber 5 via the axial bore 25 to allow fuel to enter the pumping chamber 5. When the inlet valve member 19 is in said closed position (i.e. the annular valve 27 is seated in the top valve seat 29), the pumping chamber 5 is in fluid communication exclusively with the outlet valve 9 via the axial bore 25.

The outlet valve 9 controls the supply of pressurised fuel from the pumping chamber 5 to the high pressure manifold 3. An axial communication channel 33 is formed in the pump head 3 to provide a fluid pathway from the pumping chamber 5 to the outlet valve 9. The outlet valve 9 comprises a movable outlet valve member 34, an outlet return spring 35, and an outlet valve seat 37. The outlet return spring 35 biases the outlet valve member 34 towards the outlet valve seat 37 to close the outlet valve 9. The biasing force of the outlet return spring 35 on the outlet valve member 34 and the hydraulic pressure of fuel in the high pressure manifold 13 must be overcome to open the outlet valve 9.

The pump unit 1 comprises a coupling means for coupling the plunger 15 to the inlet valve member 19. In the present embodiment, the coupling means is in the form of a permanent magnet 39 disposed at a first end 41 of the plunger 15 for releasably engaging the inlet valve member 19. The inlet valve member 19 is formed from a ferrous material to establish a magnetic coupling with the magnet 39. The magnet 39 has a cylindrical shape and is arranged to locate within a complementary aperture 43 formed in the inlet valve member 19. The aperture 43 can, for example, be an axial bore in the inlet valve member 19. In the present embodiment, the aperture 43 has a conical profile for receiving the magnet 39. When the plunger 15 is in its uppermost position at the end of the pumping stroke (i.e. in the top dead centre position), the first end 41 of the plunger 15 is positioned proximal to the inlet valve member 19 and the magnet 39 establishes a magnetic coupling between the plunger 15 and the inlet valve member 19. The aperture 43 is sized such that a radial gap of approximately 50 μm is maintained between the magnet 39 and the inlet valve member 19 when the plunger 15 is in its uppermost position.

The magnet 39 form a magnetic coupling between the plunger 15 and the inlet valve member 19. In use, the magnet 39 can transfer a lifting force from the plunger 15 to the inlet valve member 19. The magnetic coupling is established when the plunger 15 reaches its top dead centre position (i.e. its uppermost position in the illustrated arrangement). The direction of travel of the plunger 15 is then reversed to initiate the filling stroke (i.e. a downward stroke in the illustrated arrangement) and the magnet 39 transfers a lifting force from the plunger 15 to the inlet valve member 19. A hydraulic force is applied to the inlet valve member 19 as a result of the pressure differential established across the inlet valve member 19 during the filling stroke. The inlet valve member 19 can be controlled solely by the hydraulic force, as described in the Applicant's co-pending application WO 2011/003789 which is incorporated herein in its entirety by reference. In the present arrangement, the coupling established by the magnet 39 applies a lifting force to the inlet valve member 19 as the plunger 15 begins its filling stroke. The application of the lifting force can reduce the pressure differential required to unseat the annular valve 27; or the lifting force could be sufficient to unseat the annular valve 27 before the pressure differential is established. At least in certain embodiments, this allows improved control of the inlet valve member 19, for example the time taken for the inlet valve member 19 to open the pumping chamber 5 can be reduced. This has particular application at low speeds and/or low pressure (for example during start-up) when the resulting hydraulic force applied to the inlet valve member 9 is lower. At least in certain embodiments, the application of a lifting force to the inlet valve member 19 can provide earlier opening of the pumping chamber 5 and this can be desirable at high operating speeds.

The length of the stroke (i.e. the axial movement) performed by the inlet valve member 19 is less than that of the plunger 15 (to allow the inlet valve member 19 to seal the pumping chamber 5 as the plunger 15 performs its pumping stroke). To accommodate the different stroke lengths, the plunger 15 and the inlet valve member 19 are decoupled partway through the filling stroke performed by the plunger 15. Specifically, the inlet valve member 19 is displaced to its open position and the collar 23 abuts the annular stop 30 formed in the barrel 18; further movement of the inlet valve member 19 is inhibited. The continued movement of the plunger 15 overcomes the coupling force applied by the magnet 39, causing the inlet valve member 19 and the plunger 15 to decouple. The plunger 15 can complete the filling stroke with the inlet valve member 19 held in its open position by the resulting pressure differential.

The application of a lifting force to the inlet valve member 19 can facilitate modifications to the design of the annular valve 27. Notably, the location of the seal line formed between the annular valve 27 and the top valve seat 29 can be shifted radially outwardly in comparison to a valve relying solely on pressure differential to displace the inlet valve member 19. The diameter of the annular valve 27 can, for example, be increased to create a longer seal line. This potentially requires an increase in the operating force required to actuate the inlet valve member 19, but this would be offset with a reduction in the required lift (i.e. the axial travel) to operate the inlet valve member 19. The operating speed of the inlet valve member 19 can thereby be increased and, at least in certain embodiments, this may provide improved efficiency.

The operation of the pump unit 1 according to the present invention will now be described. In response to the rotation of the drive camshaft, the plunger 15 performs a pumping cycle comprising a pumping stroke (travelling upwards in the illustrated arrangement) and a filling stroke (travelling downwards in the illustrated arrangement). During the pumping stroke, the plunger 15 advances within the bore 17 and establishes a positive pressure differential across the inlet valve member 19. The pressure differential displaces the inlet valve member 19 to its closed position, thereby closing the pumping chamber 5. The continued advancement of the plunger 15 pressurises the fuel contained within the pumping chamber 5. When the pressure in the pumping chamber 5 is sufficient to overcome the spring bias of the outlet return spring 35 and the hydraulic pressure of the high pressure fuel in the manifold 13, the outlet valve member 34 lifts off the outlet valve seat 37 and high pressure fuel is expelled from the pumping chamber 5 into the manifold 13.

When the plunger 15 reaches its uppermost position (i.e. the top dead centre position), the magnet 39 is positioned within the cylindrical aperture 43 formed in the inlet valve member 19. The magnetic force applied by the magnet 39 couples the plunger 15 to the inlet valve member 19. The direction of travel of the plunger 15 is reversed during the filling stroke. As the plunger 15 performs the filling stroke, the pressure in the pumping chamber 15 decreases and the outlet valve member 34 is seated in the outlet valve seat 37. The reduction of pressure in the pumping chamber 5 establishes a negative pressure differential across the inlet valve member 19 which applies a hydraulic force to the inlet valve member 19. The magnetic coupling established between the plunger 15 and the inlet valve member 19 transfers a lifting force from the plunger 15 to the inlet valve member 19. The lifting force complements the hydraulic force and the inlet valve member 19 is displaced towards its open position. The pumping chamber 5 is thereby opened and low pressure fuel enters from the low pressure inlet gallery 11.

The plunger 15 and the inlet valve member 19 travel together within the bore 17 over an initial portion of the filling stroke. However, the stroke length of the inlet valve member 19 is shorter than that of the plunger 15 and the inlet valve member 19 decouples from the plunger 15 once in its fully open position. Specifically, the collar 23 formed in the inlet valve member 19 abuts the annular stop 30 of the barrel 18 thereby inhibiting further movement of the inlet valve member 19. The continued movement of the plunger 15 (as it completes its filling stroke) overcomes the coupling force applied by the magnet 39 and the inlet valve member 19 is released. The pressure differential across the inlet valve member 19 retains it in its open position as the plunger 15 completes the filling stroke.

The direction of travel of the plunger 15 is reversed to perform the next pumping stroke. The movement of the plunger 15 in an upwards direction again reverses the pressure differential across the inlet valve member 19. The inlet valve member 19 is thereby displaced to its closed position with the annular valve 27 seated in the top valve seat 29. The pumping chamber 5 is closed and the continued movement of the plunger 15 pressurises the fuel therein. The process is repeated by the continued reciprocation of the plunger 15.

The pump unit 1 could optionally be arranged to control movement of the inlet valve member 19 to meter the volume of fuel within the pumping chamber 5. The pump unit 1 could be modified to provide a latch including a solenoid for selectively engaging an armature disposed on the cylindrical body 21 of the inlet valve member 19. Specifically, the solenoid could be configured to operate to retain the inlet valve member 19 in its closed position, thereby inhibiting the supply of low pressure fuel from the inlet gallery 11. This arrangement is described in the Applicant's co-pending application European patent application number EP12183360.2 filed on 6 Sep. 2012, the contents of which are incorporated herein in their entirety by reference. The operation of the latch is unchanged from the arrangement described in the earlier application, but it will be appreciated that, in order to meter the volume of fuel entering the pumping chamber 5 from the inlet gallery 11, the energised solenoid must generate sufficient latching force to decouple the inlet valve member 19 from the plunger 15 during a filling stroke. Various aspects of the present invention will now summarised with reference to the accompanying numbered paragraphs.

1. A pump unit for a fuel injection system, the pump unit comprising:

a low pressure fuel supply line;

a pumping chamber having a plunger operable to perform a pumping cycle comprising a pumping stroke and a filling stroke;

an inlet valve having an inlet valve member movable between an open position for permitting the supply of fuel to the pumping chamber from the low pressure fuel supply line and a closed position for inhibiting the supply of fuel from the pumping chamber to the low pressure supply line; and

a high pressure fuel outlet having an outlet valve;

wherein the pump unit further comprises a coupling configured to couple the plunger to the inlet valve member.

2. A pump unit as described in paragraph 1, wherein the coupling is operable to apply a lifting force to the inlet valve member during the filling stroke performed by said plunger.

3. A pump unit as described in paragraph 1, wherein the coupling is configured releasably to couple the plunger to the inlet valve member.

4. A pump unit as described in paragraph 1 comprising a decoupler for decoupling the plunger and the inlet valve member.

5. A pump unit as described in paragraph 4, wherein the decoupler comprises a valve stop which defines said open position of the inlet valve member.

6. A pump unit as described in paragraph 1, wherein the coupling comprises at least one permanent magnet and/or at least one electromagnet.

7. A pump unit as described in paragraph 6, wherein said at least one permanent magnet and/or said at least one electromagnetic is disposed on the plunger and/or the inlet valve member.

8. A pump unit as described in paragraph 1, wherein the coupling comprises a mechanical coupling.

9. A pump unit as described in paragraph 8, wherein the mechanical coupling comprises a coupling member disposed on one of said plunger and inlet valve member for engaging the other of said plunger and inlet valve member.

10. A pump unit as described in paragraph 9, wherein the coupling member is a resilient member or is spring biased.

11. A pump unit as described in paragraph 1, wherein the coupling comprises a hydraulic coupling.

12. A pump unit for a fuel injection system, the pump unit comprising:

a plunger disposed in a pumping chamber and operable to perform a pumping cycle;

an inlet valve having an inlet valve member movable between an open position for permitting the supply of fuel to the pumping chamber and a closed position for inhibiting the supply of fuel from the pumping chamber to the low pressure supply line; and

wherein the pump unit further comprises a coupling configured to couple the plunger to the inlet valve member.

13. A method of operating a pump unit, the method comprising:

reciprocating a plunger within a pumping chamber to perform a pumping cycle comprising a pumping stroke and a filling stroke;

displacing an inlet valve member between an open position for permitting the supply of fuel to the pumping chamber from a low pressure fuel supply line and a closed position for inhibiting the supply of fuel from the pumping chamber to the low pressure supply line;

coupling the plunger to the inlet valve member to lift the inlet valve member from said closed position.

14. A method as described in paragraph 13, comprising:

decoupling the plunger and the inlet valve member partway through the filling stroke of the plunger.

15. A method as described in paragraph 13, wherein the plunger is coupled to the inlet valve member as the plunger completes said pumping stroke.

1. A pump unit for a fuel injection system, the pump unit comprising:
a low pressure fuel supply line;
a pumping chamber having a plunger operable to perform a pumping cycle comprising a pumping stroke and a filling stroke;
an inlet valve having an inlet valve member movable between an open position for permitting the supply of fuel to the pumping chamber from the low pressure fuel supply line and a closed position for inhibiting the supply of fuel from the pumping chamber to the low pressure supply line; and
a high pressure fuel outlet having an outlet valve;
wherein the pump unit further comprises coupling means for coupling the plunger to the inlet valve member characterized in that
the pump unit further comprises means for decoupling the plunger and the inlet valve member, the decoupling means comprising a valve stop which defines said open position of the inlet valve member.

2. A pump unit as claimed in claim 1, wherein the coupling means is operable to apply a lifting force to the inlet valve member during the filling stroke performed by said plunger.

3. A pump unit as claimed in claim 1, wherein the coupling means is suitable for releasably coupling the plunger to the inlet valve member.

4. A pump unit as claimed in claim 1, wherein the coupling means comprises at least one permanent magnet and/or at least one electromagnet.

5. A pump unit as claimed in claim 4, wherein said at least one permanent magnet and/or said at least one electromagnetic is disposed on the plunger and/or the inlet valve member.

6. A pump unit as claimed in claim 1, wherein the coupling means comprises a mechanical coupling.

7. A pump unit as claimed in claim 6, wherein the mechanical coupling comprises a coupling member disposed on one of said plunger and inlet valve member for engaging the other of said plunger and inlet valve member.

8. A pump unit as claimed in claim 7, wherein the coupling member is a resilient member or is spring biased.

9. A pump unit as claimed in claim 1, wherein the coupling means comprises a hydraulic coupling.

10. A method of operating a pump unit, the method comprising:
reciprocating a plunger within a pumping chamber to perform a pumping cycle comprising a pumping stroke and a filling stroke;
displacing an inlet valve member between an open position for permitting the supply of fuel to the pumping chamber from a low pressure fuel supply line and a closed position for inhibiting the supply of fuel from the pumping chamber to the low pressure supply line;
coupling the plunger to the inlet valve member to lift the inlet valve member from said closed position.

11. A method as claimed in claim 10, comprising:
decoupling the plunger and the inlet valve member partway through the filling stroke of the plunger.

12. A method as claimed in claim 10, wherein the plunger is coupled to the inlet valve member as the plunger completes said pumping stroke.
